(19) United States
(12) Patent Application Publication
(10) Pub. No.: US 2022/0132375 A1
(43) Pub. Date: Apr. 28, 2022

(54) ENFORCEMENT OF INTEGRITY PROTECTED DATA RATE FOR USER EQUIPMENT

(71) Applicant: NEC Corporation, Minato-ku, Tokya (JP)

(72) Inventors: Chadi KHIRALLAH, Epsom (GB); Jagdeep Ahluwalia SINGH, Sutton (GB); Sadafuku HAYASHI, Tokyo (JP); Neeraj GUPTA, Sutton (GB)

(73) Assignee: NEC Corporation, Minato-ku, Takyo (JP)

(21) Appl. No.: 17/429,814

(22) PCT Filed: Feb. 12, 2020
(86) PCT No.: PCT/JP2020/005292

§ 371 Date: Aug. 10, 2021

(30) Foreign Application Priority Data
Feb. 15, 2019 (GB) 1902167.4

(51) Int. Cl. H04W 28/22

(52) U.S. Cl. CPC H04W 28/22; H04W 12/10

(57) ABSTRACT

A communication system is disclosed in which a base station apparatus obtains, from at least one secondary node (SN) handling user-plane transmissions for a user equipment (UE), information identifying a total integrity protected data rate for all Protocol Data Unit (PDU) sessions associated with the UE at that SN. When the information from the at least one SN indicates that the total integrity protected data rate for all PDU sessions associated with the UE at that SN exceeds an associated data rate portion, the base station apparatus updates at least one of: said data rate portion; and at least one PDU session associated with the UE at that SN.

This application is a National Stage Entry of PCT/JP2020/005292 filed on Feb. 12, 2020, which claims priority from British Patent Application 1902167.4 filed on Feb. 15, 2019, the contents of all of which are incorporated herein by reference, in their entirety.

### TECHNICAL FIELD

The present invention relates to a wireless communication system and devices thereof operating according to the 3rd Generation Partnership Project (3GPP) standards or equivalents or derivatives thereof. The disclosure has particular but not exclusive relevance to improvements relating to enforcement of integrity protected data rate for user equipment in the so-called ‘5G’ (or ‘Next Generation’) systems.

### BACKGROUND ART

The latest developments of the 3GPP standards are the so-called ‘5G’ or ‘New Radio’ (NR) standards which refer to an evolving communication technology that is expected to support a variety of applications and services such as Machine Type Communications (MTC), Internet of Things (IoT) communications, vehicular communications and autonomous cars, high resolution video streaming, smart city services, and/or the like. 5G technologies enable network access to vertical markets and support network (RAN) sharing for offering networking services to third parties and for creating new business opportunities. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V15.4.0 and TS 37.340 V15.4.0 define the following nodes, amongst others:
gNB: node providing NR user plane and control plane protocol terminations towards the UE, and connected via the NG interface to the 5G core network (5GC).
ng-eNB: node providing Evolved Universal Terrestrial Radio Access (E-UTRA) user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).
NG-RAN node: either a gNB or an ng-eNB.

3GPP also defined the so-called ‘Xn’ interface as the network interface between neighbouring NG-RAN nodes.

Recently, it has also been proposed that the functionality of a gNB (referred to herein as a ‘distributed’ gNB) may be split between one or more distributed units (DUs) and a central unit (CU) with a CU typically performing higher level functions and communication with the next generation core and with the DU performing lower level functions and communication over an air interface with user equipment (UE) in the vicinity (i.e. in a cell operated by the gNB). Specifically, 3GPP TS 38.401 V15.4.0 specifies the following functional units:
gNB Central Unit (gNB-CU): a logical node hosting Radio Resource Control (RRC), Service Data Adaptation Protocol (SDAP) and Packet Data Convergence Protocol (PDCP) layers of the gNB or RRC and PDCP layers of the En-gNB that controls the operation of one or more gNB-DUs. The gNB-CU terminates the F1 interface connected with the gNB-DU.
gNB Distributed Unit (gNB-DU): a logical node hosting Radio Link Control (RLC), Medium Access Control (MAC) and Physical (PHY) layers of the gNB or En-gNB, and its operation is partly controlled by gNB-CU. One gNB-DU supports one or multiple cells. One cell is supported by only one gNB-DU. The gNB-DU terminates the F1 interface connected with the gNB-CU.
gNB-CU-Control Plane (gNB-CU-CP): a logical node hosting the RRC and the control plane part of the PDCP protocol of the gNB-CU for an En-gNB or a gNB. The gNB-CU-CP terminates the E1 interface connected with the gNB-CU-UP and the F1-C interface connected with the gNB-DU.
gNB-CU-User Plane (gNB-CU-UP): a logical node hosting the user plane part of the PDCP protocol of the gNB-CU for an En-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU.

In accordance with 3GPP TS 38.401, the overall architecture for separation of gNB-CU-CP and gNB-CU-UP is based on the following principles:
a gNB may consist of a gNB-CU-CP, multiple gNB-CU-UPs and multiple gNB-DUs;
one gNB-DU is connected to only one gNB-CU-CP;
one gN-CU-UP is connected to only one gNB-CU-CP;
one gNB-DU can be connected to multiple gNB-CU-UPs under the control of the same gNB-CU-CP; and
one gN-CU-UP can be connected to multiple DUs under the control of the same gNB-CU-CP.

However, it will be appreciated that for resiliency a gNB-DU and/or a gNB-CU-UP may be connected to multiple gNB-CU-CPs. The connectivity between a gNB-CU-UP and a gNB-DU is established by the gNB-CU-CP using Bearer Context Management functions. The gNB-CU-CP selects the appropriate gNB-CU-UP(s) for the requested services for the UE. When multiple CU-UPs are used, the CU-UPs belong to same security domain as defined in TS 33.210 V15.2.0.

The general aspects and principles relating to the E1 interface (between the gNB-CU-CP and the gNB-CU-UP) are described in 3GPP TS 38.460 V15.2.0. The E1 interface supports various interface management relevant procedures, such as setup, configuration update, reset, release, error indication, and/or the like.

3GPP TS 23.501 V15.4.0 describes that when a UE is involved in a Protocol Data Unit (PDU) session with User Plane (UP) security, an appropriate data rate may need to be enforced for that PDU session. Specifically, the NG-RAN applies User Plane security policies for a PDU session based on the relevant User Plane Security Enforcement information.

The User Plane Security Enforcement information indicates whether UP integrity protection is:
Required (for all the traffic on the PDU Session UP integrity protection shall apply);
Preferred (for all the traffic on the PDU Session UP integrity protection should apply, although this is not a mandatory requirement); or
Not Needed (UP integrity protection shall not apply on the PDU Session).

The User Plane Security Enforcement information also indicates whether UP confidentiality protection is:
Required (for all the traffic on the PDU Session UP confidentiality protection shall apply);
Preferred (for all the traffic on the PDU Session UP confidentiality protection should apply, although this is not a mandatory requirement); or
Not Needed (UP confidentiality shall not apply on the PDU Session).

User Plane Security Enforcement information applies only over 3GPP access. Once determined at the establishment of the PDU Session the User Plane Security Enforcement information applies for the life time of the PDU Session.

The so-called Session Management Function (SMF) determines at PDU session establishment a User Plane Security Enforcement information for the user plane of a PDU session based on (one or more of) the following:
subscribed User Plane Security Policy which is part of SM subscription information received from Unified Data Management (UDM);
locally configured User Plane Security Policy (per Data Network Name (DNN)/Single Network Slice Selection Assistance Information (S-NSSAI)) in the SMF (e.g. when the UDM does not provide User Plane Security Policy information); and
the maximum supported data rate per UE for integrity protection for the Data Radio Bearers (DRBs), indicated by the UE during the PDU Session Establishment.

3GPP agreed to limit the maximum data rate per UE for integrity protection of DRBs (at least for Rel-15). 3GPP TS 38.300, section 13.1 states that the maximum supported data rate for integrity protected DRBs is a UE capability indicated at Non-Access Stratum (NAS) layer, with a minimum value of 64 kbps and a maximum value of the highest data rate supported by the UE.

The User Plane Security Enforcement information is communicated from SMF to the NG-RAN for enforcement as part of PDU session related information. If the UP Integrity Protection is determined to be “Required” or “Preferred”, the SMF also provides the maximum supported data rate per UE for integrity protection as received in the ‘5GSM capability’ information element (IE). This takes place at establishment of a PDU Session or at activation of the user plane of a PDU Session. The NG-RAN rejects the establishment of UP resources for the PDU Session when it cannot fulfil User Plane Security Enforcement information with a value of Required. The NG-RAN may also take the maximum supported data rate per UE for integrity protection into account in its decision on whether to accept or reject the establishment of UP resources. In this case the SMF releases the PDU Session. The NG-RAN notifies the SMF when it cannot fulfil a User Plane Security Enforcement with a value of Preferred. For example, the NG-RAN cannot fulfill requirements in User Plane Security Enforcement information with UP integrity protection set to “Required” when it cannot negotiate an appropriate UP integrity protection with the UE.

The User Plane Security Enforcement information and the maximum supported data rate per UE for integrity protection is communicated from source to target NG-RAN node at handover. If the target RAN node cannot support requirements in User Plane Security Enforcement information, the target RAN node rejects the request to setup resources for the PDU Session. In this case the PDU Session is not handed over to the target RAN node and the PDU Session is released.

When the UE is served by more than one base station, each serving base station handles at least a part of the UE's User Plane communications. For example, the UE may be served by a gNB configured as a Master Node (MN) and also served by another gNB configured as a Secondary Node (SN). Similarly, the UE may be served by multiple units of a distributed gNB. Thus, in order to perform data rate enforcement when the UE's PDU session involves more than one base station, a “portion” of the UE maximum integrity protected data rate is enforced by each serving base station. Specifically, when the UE is served by an MN and an SN, the MN signals a “portion” of the (total) UE maximum IP data rate for enforcement by the receiving SN. The applicable portion is included in the Maximum Integrity Protected Data Rate IE sent to the SN. It will be appreciated that the “Portion” is a hard limit that is sent from MN to SN (inter-node), or from SN-CU-CP to SN-CU-UP (intra-node).

The inventors have identified a number of problems relating to data rate enforcement when the UE's PDU session involves more than one base station.

Specifically, in case of inter-node interaction, the MN and SN need to ensure that the “UE Maximum IP data rate” is not exceeded on the UE's MN terminated and SN terminated PDU sessions, respectively. Thus, the MN signals a “portion” of the total “UE Maximum IP data rate” for enforcement by the SN for the SN terminated PDU sessions. However, 3GPP has not specified any mechanism for coordination between the MN and SN on choosing an appropriate value of “portion”. Moreover, in some cases the SN may not be able to handle the requirements for the “portion” of UE Maximum IP data rate signalled by the MN (e.g. the signalled “portion” value may be too high to fulfil based on local status of SN resources). It is also not clear how to handle situations when the aggregate integrity protected data rate on the SN terminated PDU sessions exceeds the MN assigned “portion” in on-going traffic at the SN.

Regarding the case of intra-node interaction, the inventors realised that a single CU-CP may be connected to one or more CU-UPs and the UE may be running one or more services (e.g. one service/PDU session per CU-UP), simultaneously. In this case, the CU-CP and CU-UP(s) need to ensure that the “UE Maximum IP data rate” does not exceed on both UL and DL traffic. When the CU-CP signals the appropriate “portion” of the “UE Maximum IP data rate” for enforcement by the CU-UPs (connected to that CU-CP), the CU-CP needs to signal appropriate sub-portions to each CU-UP, and the sum of these “sub-portions” should be less than or equal to the total “portion”.

### SUMMARY OF INVENTION

However, 3GPP has not specified any mechanism for coordination between CU-CP and CU-UP(s) on choosing an appropriate value of “portion(s)” or “sub-portions” applicable at a given CU-UP. The inventors realised that in some cases one or more CU-UPs may not be able to handle the requirements for the signalled “portion(s)” of UE Maximum IP data rate (e.g. the signalled portion/sub-portion value may be too high to be handled by lower layer configuration and/or resource status at the given CU-UP).

Even in cases involving a single CU-CP/CU-UP pair, it is not clear how the CU-CP/CU-UP should handle the situation when the aggregate integrity protected PDU session data rate on the CU-UP exceeds the applicable “portion”. In the case of multiple CU-UPs, it is not clear how the CU-CP/CU-UPs should handle if the aggregate integrity protected data rate on all PDU sessions (of all CU-UPs) exceeds the total “portion”.

Accordingly, the present invention seeks to provide methods and associated apparatus that address or at least alleviate (at least some of) the above described problems.

The present invention provides a method performed by a base station apparatus, the method comprising: obtaining, from at least one secondary node (SN) handling user-plane transmissions for a user equipment (UE), information identifying a total integrity protected data rate for all Protocol Data Unit (PDU) sessions associated with the UE at that SN; and when the information from the at least one SN indicates that the total integrity protected data rate for all PDU sessions associated with the UE at that SN exceeds an associated data rate portion, updating at least one of: said data rate portion; and at least one PDU session associated with the UE at that SN.

The present invention provides a method performed by a base station apparatus configured as a secondary node (SN) handling user-plane transmissions for a user equipment (UE), the method comprising: providing, to a master node (MN) or a control-plane unit, information identifying a total integrity protected data rate for all Protocol Data Unit (PDU) sessions associated with the UE at that SN; and when the total integrity protected data rate for all PDU sessions associated with the UE at that SN exceeds an associated data rate portion, updating at least one of: said data rate portion; and at least one PDU session associated with the UE at that SN.

The present invention provides a method performed by a core network node handling user-plane transmissions for a user equipment (UE), the method comprising: providing, to a master node (MN), information indicating that a total of integrity protected traffic for at least one Protocol Data Unit (PDU) session associated with the UE has reached a predetermined level.

Exemplary aspects of the invention extend to corresponding systems, apparatus, and computer program products such as computer readable storage media having instructions stored thereon which are operable to program a programmable processor to carry out a method as described in the exemplary aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Exemplary embodiments of the invention will now be described, by way of example, with reference to the accompanying drawings in which:

FIG. 1 illustrates schematically a generic mobile (cellular or wireless) telecommunication system to which exemplary embodiments of the invention may be applied;

FIG. 2 illustrates schematically a mobile (cellular or wireless) telecommunication system, including a master node and a secondary node, to which exemplary embodiments of the invention may be applied;

FIG. 3 illustrates further details of a master node and a secondary node in the system shown in FIG. 2;

FIG. 4 illustrates schematically a mobile (cellular or wireless) telecommunication system, including a distributed base station, to which exemplary embodiments of the invention may be applied;

FIG. 5 illustrates further details of the distributed base station in the system shown in FIG. 4;

FIG. 6 is a schematic block diagram of a mobile device (user equipment) forming part of the systems shown in FIGS. 1, 2, and 4;

FIG. 7 is a schematic block diagram of a base station apparatus forming part of the systems shown in FIGS. 1, 2, and 4;

FIG. 8 is a schematic block diagram of a core network node forming part of the systems shown in FIGS. 1, 2, and 4; and

FIG. 9 illustrates schematically some exemplary ways in which exemplary embodiments of the present invention may be implemented in the systems shown in FIGS. 1, 2, and 4.

FIG. 10 illustrates schematically some exemplary ways in which exemplary embodiments of the present invention may be implemented in the systems shown in FIGS. 1, 2, and 4.

### DESCRIPTION OF EMBODIMENTS

Overview

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect IoT devices and similar MTC devices to the network. For simplicity, the present application will use the term base station to refer to any such base stations and use the term mobile device or UE to refer to any such communication device.

Although for efficiency of understanding for those of skill in the art, the invention will be described in detail in the context of a 3GPP system (a 5G network), the principles of the invention can be applied to other systems in which slice scheduling is performed.

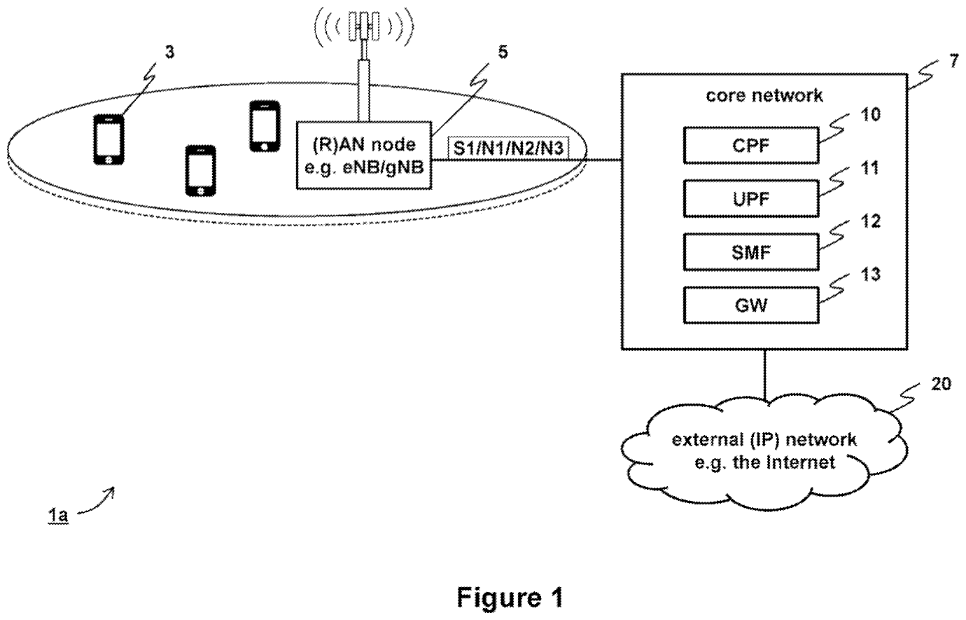

FIG. 1 illustrates schematically a mobile (cellular or wireless) telecommunication system 1a to which exemplary embodiments of the invention may be applied.

In this network, users of mobile devices 3 (UEs) can communicate with each other and other users via respective base stations 5 and a core network 7 using an appropriate 3GPP radio access technology (RAT), for example, an E-UTRA and/or 5G RAT. It will be appreciated that a number of base stations 5 form a (radio) access network or (R)AN. As those skilled in the art will appreciate, whilst three mobile devices 3 and one base station 5 are shown in FIG. 1 for illustration purposes, the system, when implemented, will typically include other base stations and mobile devices (UEs).

A base station 5 that supports E-UTRA/4G protocols may be referred to as an ‘eNB’ and a base station 5 that supports NextGeneration/5G protocols may be referred to as a ‘gNBs’. The base station 5 in FIG. 1 is configured to operate in accordance with next generation (5G) standards. However, it will be appreciated that the base station 5 may be configured to support both 4G and 5G, and/or any other 3GPP or non-3GPP communication protocols.

Neighbouring base stations 5 are connected to each other via an appropriate base station to base station interface (such as the so-called ‘Xn’ interface, the ‘X2’ interface, and/or the like). The base stations 5 are connected to the core network nodes via an appropriate interface (such as the so-called ‘S1’, ‘N1’, ‘N2’, ‘N3’ interface, and/or the like). The core network 7 (e.g. the 5GC in case of NR/5G or the EPC in case of LTE) typically includes logical nodes (or ‘functions’) for supporting communication in the telecommunication system 1a, and for subscriber management, mobility management, charging, security, call/session management (amongst others). For example, the core network 7 of a ‘Next Generation’/5G system will include, amongst other functions, control plane functions (CPFs) 10 and user plane functions (UPFs) 11. It will be appreciated that a CPF 10 may be configured to provide one or more of the following (amongst others): a Session Management Function (SMF) 12 (shown separately in FIG. 1), an Access and Mobility Function (AMF), a Policy Control Function (PCF), an Operations and Maintenance (OAM) function, an Application Function (AF), and/or a Network Function (NF). The core network 7 also comprises at least one gateway (GW) 13 (e.g. a serving gateway) for coupling the core network 7 to the RAN (base station 5) and to an external network 20 (typically an Internet Protocol (IP) network, such as the Internet).

When the UE 3 initiates a PDU session via its serving base station 5, the base station 5 checks whether the PDU session requires integrity protection and whether it is necessary to enforce a maximum data rate for the UE's integrity protected Data Radio Bearers (DRBs) terminated at that base station 5. Specifically, the base station 5 applies User Plane security policies for a PDU session based on the relevant User Plane Security Enforcement information (when the relevant User Plane Security Enforcement information indicates that UP integrity protection is ‘Required’ or ‘Preferred’).

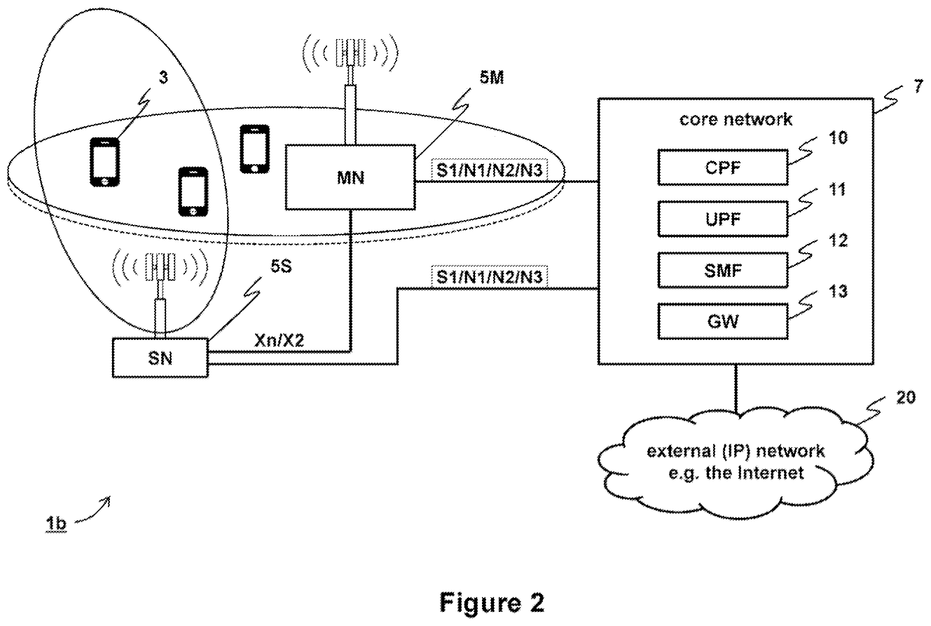

Turning now to FIG. 2, the mobile (cellular or wireless) telecommunication system 1b of this figure is effectively the same as the one shown in FIG. 1. However, the UE 3 in this case is served by a base station configured as a master node (MN) 5M and by a base station configured as a secondary node (SN) 5S. In this case, the MN 5M checks whether the PDU session requires integrity protection and whether it is necessary to enforce a maximum data rate for the UE's integrity protected Data Radio Bearers (DRBs) via the MN 5M and SN 5S serving the UE 3. Specifically, the MN 5M applies User Plane security policies for a PDU session based on the relevant User Plane Security Enforcement information (when it is set to ‘Required’ or ‘Preferred’).

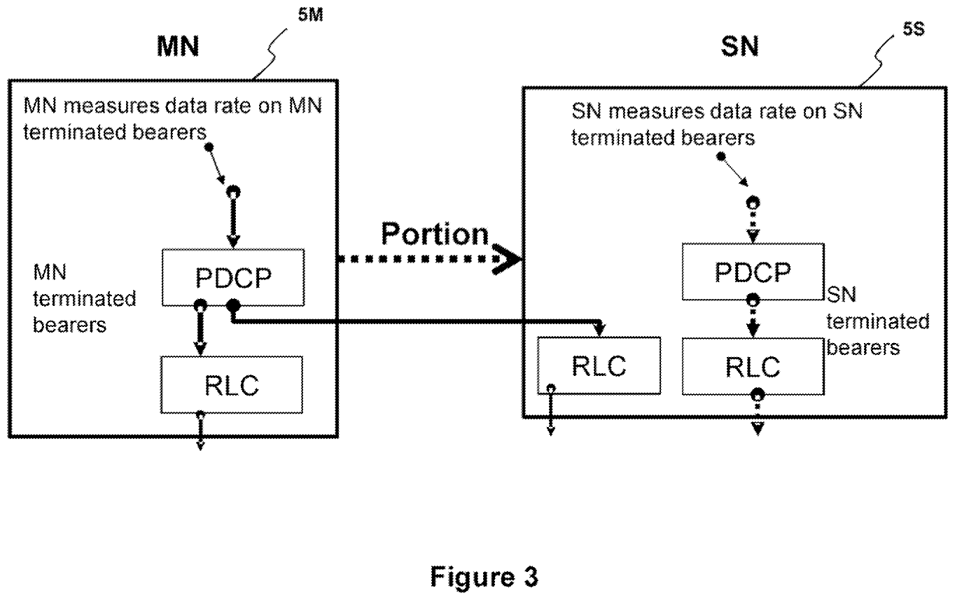

As shown in FIG. 3, both the MN 5M and the SN 5S host respective parts of the Radio Link Control (RLC) and the Packet Data Convergence Protocol (PDCP) layer for the DRB(s) served by that node (for the UE's User Plane). Although not shown in FIG. 3, it will be appreciated that the MN 5M and the SN 5S will also host corresponding lower layers such as the Medium Access Control (MAC) layer and the Physical (PHY) layer for their DRBs.

The MN 5M measures the data rate on bearers (DRBs) terminated at the MN 5M and the SN 5S measures the data rate on bearers (DRBs) terminated at the SN 5S. The MN 5M can signal a “portion” of the (total) UE maximum IP data rate for enforcement by the SN 5S (or signal respective portions/sub-portions to multiple SNs if appropriate). In more detail, the applicable portion (or information identifying the portion) is included in the Maximum Integrity Protected Data Rate IE of a signalling message sent to the SN 5S (e.g. when a PDU session is established for the UE 3).

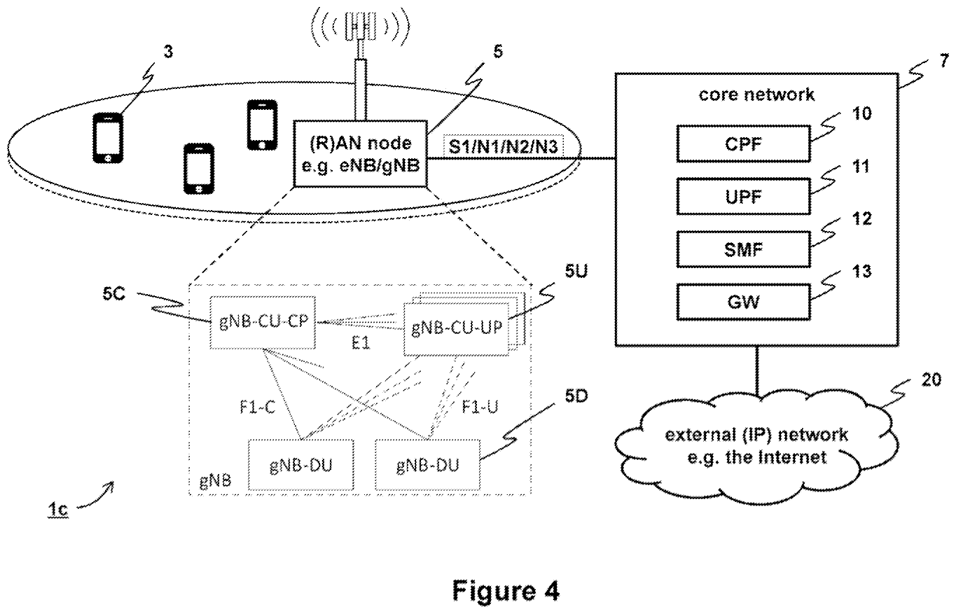

FIG. 4 illustrates a scenario in which the UE 3 is served by a distributed base station 5 (a distributed gNB). The distributed gNB 5 in the mobile (cellular or wireless) telecommunication system 1c comprises a central unit for the control plane (gNB-CU-CP) 5C, at least one central unit for the user plane (gNB-CU-UP) 5U, and a plurality of distributed units (gNB-DU) 5D each serving at least one associated cell. It will be appreciated that some components of the distributed gNB 5 (e.g. the gNB-CU-CP 5C and/or at least one the gNB-CU-UP 5U function) may be provided in the core network 7, if appropriate. Although separate functions with specific names are described for illustrative purposes, the corresponding functionality may be implemented in isolation or combination by one or more suitable nodes implemented using dedicated circuitry and/or software instructions for controlling an associated processor.

The various sub-units (functions) of the distributed gNB 5 are coupled via appropriate interfaces as follows: the gNB-CU-CP 5C is connected to the gNB-DU 5D through the F1-C interface; the gNB-CU-UP 5U is connected to the gNB-DU 5D through the F1-U interface; and the gNB-CU-UP 5U is connected to the gNB-CU-CP 5C through the E1 interface. The mobile device 3 and the base station 5 are connected via an appropriate air interface (for example the so-called ‘Uu’ interface and/or the like). The distributed base station 5 is also connected to the core network nodes via an appropriate interface (such as the so-called ‘S1’, ‘N1’, ‘N2’, ‘N3’ interface, and/or the like).

In the above described systems 1a to 1c, the nodes serving the UE 3 are configured to co-operatively enforce the maximum data rate for the UE's integrity protected Data Radio Bearers (DRBs).

In one option, this is achieved by appropriate inter-node interaction between the MN 5M and the SN 5S. Specifically, the SN 5S may be configured to monitor (over a given time period) the integrity protected traffic on its own (SN terminated) PDU sessions and generate an associated report (and send the report to the MN 5M), either periodically, or when it triggered by an event (e.g. when the integrity protected traffic on its own (SN terminated) PDU sessions exceeds a threshold, which may be defined as a percentage (e.g. 50%, 80%, or 100%) of SN's portion of the maximum data rate for the UE's integrity protected DRBs. Depending on the configuration of the MN 5M and the SN 5S, the SN 5S may modify or release (or request the MN 5M to modify or release) PDU Session Resources allocated to the UE 3 on its integrity protected DRBs. Alternatively, the MN 5M may increase the “portion” applicable to the SN 5S (e.g. following an appropriate request from the SN 5S).

In another option, the UPF 11 may be configured to monitor the data rate for all integrity protected PDU sessions. When the UPF 11 detects that the total integrity protected UP traffic on all PDU sessions is about to reach (or it has reached) the maximum supported data rate per UE for integrity protection for all DRBs, then the UPF 11 may provide appropriate assistance information (e.g. a warning message) to the base station 5. Upon receipt of the assistance information from the UPF 11, the MN 5M may be configured to obtain a total data rate on all integrity protected PDU sessions from the SN 5S (for SN terminated DRBs), and to check whether the integrity protected PDU sessions has exceeded the applicable data rate limit. If the SN-terminated PDU sessions exceed the allocated limit (“SN portion”) then the MN 5M may for example (a) temporary drop the SN 5S or (b) change the bearer type from SN-terminated to MN-terminated bearer. If the MN-terminated PDU sessions exceed the allocated limit (“MN portion”), then the MN 5M may be configured to modify or drop one or more of its own (MN-terminated) DRBs for the PDU session.

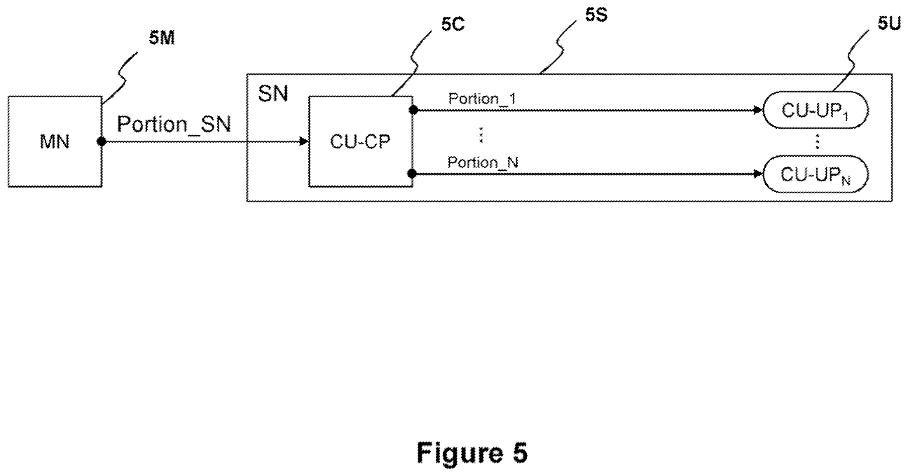

In yet another option, enforcement of the maximum data rate for the UE's integrity protected DRBs is achieved by appropriate inter-node interaction between the gNB-CU-CP 5C and the gNB-CU-UP 5U parts of a distributed gNB 5. As shown in FIG. 5, the gNB-CU-CP 5C (denoted ‘CU-CP’) and any corresponding gNB-CU-UP 5U (denoted ‘CU-UP₁’ to ‘CU-UP_{N}’) may effectively provide the functionality of a secondary node 5S. In this case, each gNB-CU-UP 5U part receives an associated sub-portion of the maximum data rate for the UE's integrity protected DRBs. It will be appreciated that different gNB-CU-UP 5U parts may have different associated sub-portions allocated to them. The gNB-CU-UP 5U parts report their associated data usage to the gNB-CU-CP 5C. In this case, based on the reported data usage, the gNB-CU-CP 5C may perform similar actions as the MN 5M in the previous option, on a per CU-UP basis. The gNB-CU-CP 5C may also update (increase/decrease) the sub-portion allocations on a per CU-UP basis, depending on the data rate reported by the CU-UP parts.

In a further option, enforcement of maximum integrity protected data rate for the split PDU session may be realised using appropriate assistance information from the core network 7 (from the UPF 11). It will be appreciated that a PDU session may be split at the UPF 11 during PDU session resource setup or PDU session resource modification. In this case, the core network 7 (AMF/SMF) signals to the base station 5 information (e.g. one or more information element) identifying: a PDF Session level Max IP data rate; a DRB level Max IP data rate; and a QoS Flow level Max IP data rate. If the integrity protected data rate per QoS flow exceeds the QoS Flow level maximum integrity protected data rate at one of the CN-UPs 5U, then that CN-UP 5U informs the CN-CP 5C about this. The CN-CP 5C may (a) temporarily drop the CN-UP 5U or (b) request the CN-UP 5U to reduce the data rate of the considered QoS flow.

It will be appreciated that when a CU-CP 5C is connected to multiple CU-UPs 5U (of a SN 5S), the CU-CP 5C may be configured to allocate (and adjust, if necessary) appropriate sub-portions of the SN's portion of the maximum integrity protected data rate to each CU-UP 5U (e.g. based on an appropriate formula).

Various exemplary messages and information elements that may be used in some (or all) of the above options are illustrated in Tables 1 to 10 in the detailed description.

User Equipment (UE)

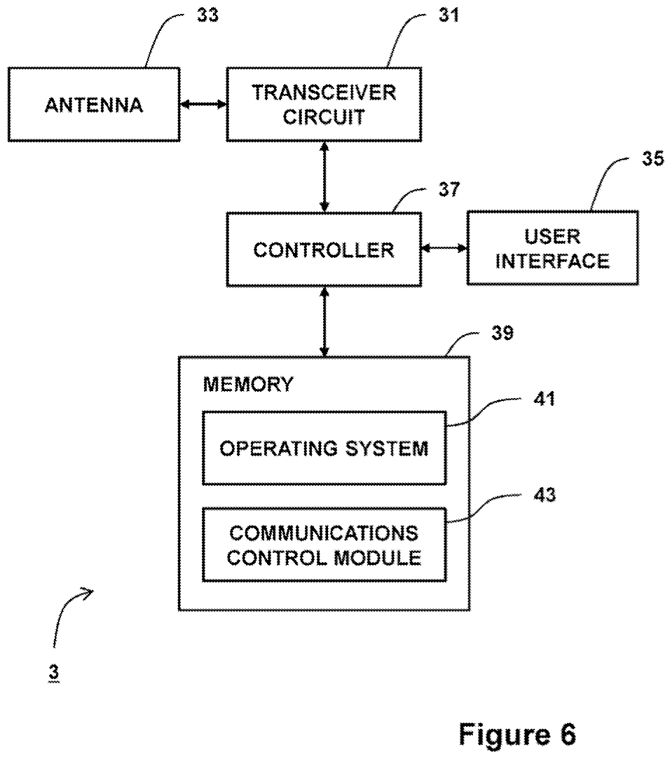

FIG. 6 is a block diagram illustrating the main components of the mobile device (UE) 3 shown in FIGS. 1a to 1c. As shown, the UE 3 includes a transceiver circuit 31 which is operable to transmit signals to and to receive signals from the connected node(s) via one or more antenna 33. Although not necessarily shown in FIG. 6, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, and at least a communications control module 43. The communications control module 43 is responsible for handling (generating/sending/receiving) signalling messages and uplink/downlink data packets between the UE 3 and other nodes, including (R)AN nodes 5 and core network nodes. Such signalling messages may include appropriately formatted messages and information elements for indicating the UE's maximum supported data rate for integrity protected DRBs. The indication may be provided to the core network 7 at the Non-Access Stratum (NAS) layer, via the RAN node 5 serving the UE 3.

Base Station

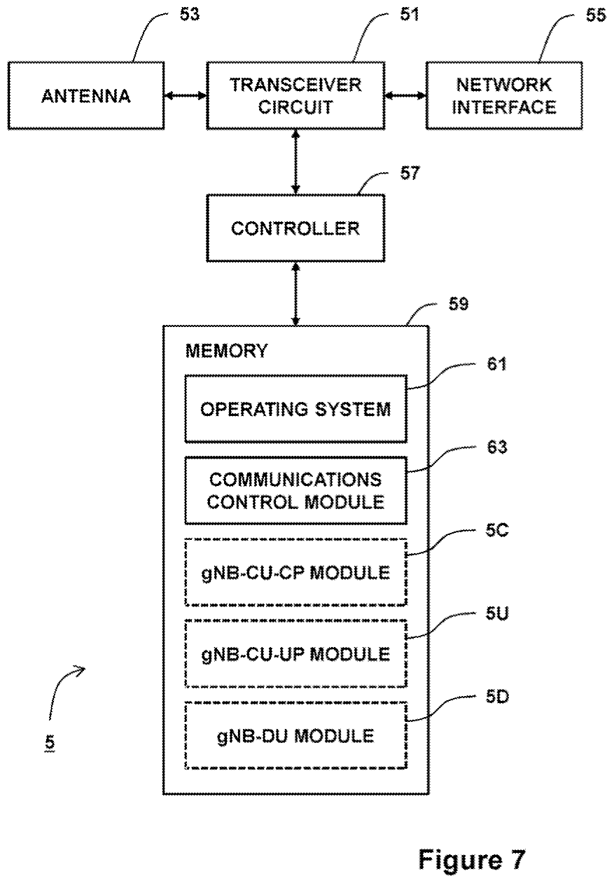

FIG. 7 is a block diagram illustrating the main components of the base station apparatus 5 shown in FIGS. 1a to 1c. As shown, the base station 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station—base station interface (such as X2/Xn) and an appropriate base station—core network interface (such as S1/N1/N2/N3).

A controller 57 controls the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, and at least a communications control module 63.

The communications control module 63 is responsible for handling (generating/sending/receiving) signalling between the base station 5 and other nodes, such as the UE 3 and the core network nodes. Such signalling messages may include appropriately formatted messages and information elements relating to the maximum data rate for integrity protected DRBs supported by a particular UE 3 served by the base station 5.

When the base station 5 operates as a MN 5M or an SN 5S, the communications control module 63 is also responsible for handling (generating/sending/receiving) signalling messages and information elements that are appropriate for the current operation of the base station 5.

When the base station 5 comprises a distributed gNB or En-gNB, the network interface 55 also includes an E1 interface and an F1 interface (F1-C for the control plane and F1-U for the user plane) to communicate signals between respective functions of the distributed gNB or En-gNB. In this case, the software also includes at least one of: a gNB-CU-CP sub-module 5C, a gNB-CU-UP sub-module 5U, and a gNB-DU sub-module 5D. In this case, each sub-module is responsible for handling (generating/sending/receiving) signalling messages and information elements in accordance with the functionality provided by that sub-module.

Core Network Node

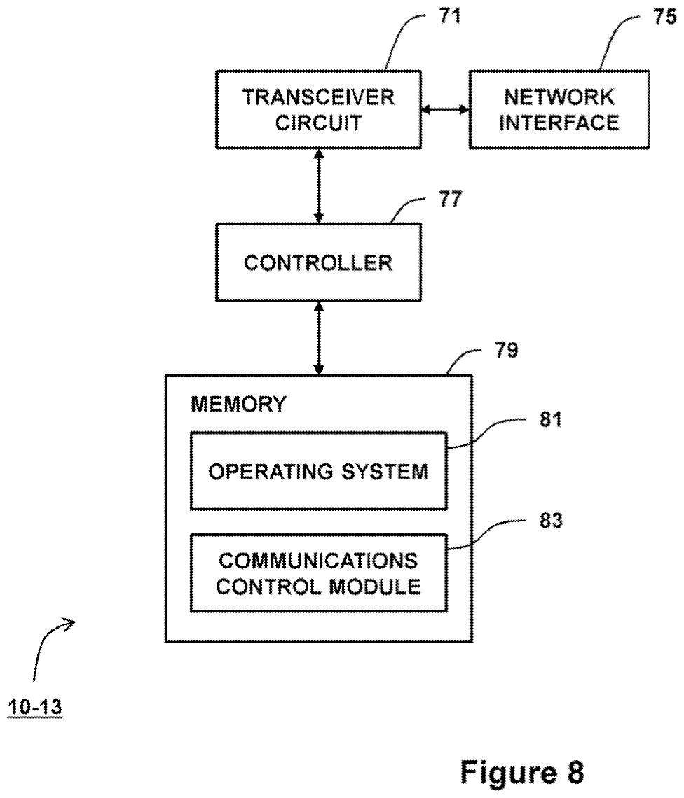

FIG. 8 is a block diagram illustrating the main components of an exemplary core network node, such as the SMF 12 shown in FIGS. 1a to 1c. As shown, the core network node includes a transceiver circuit 71 which is operable to transmit signals to and to receive signals from other nodes (including the UE 3, the base station 5, and other core network nodes) via a network interface 75. A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81, and at least a communications control module 83.

The communications control module 83 is responsible for handling (generating/sending/receiving) signaling between the core network node and other nodes, such as the UE 3, the base station 5, and other core network nodes.

In the above description, the mobile telephone, the UE, the base station, and core network node are described for ease of understanding as having a number of discrete modules. Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

### DETAILED DESCRIPTION

A number of procedures will now be described, by way of example only, which may be implemented to allow enforcement of the applicable maximum data rate for integrity protected DRBs in the above described systems 1a to 1c. It will be appreciated that whilst each of these procedures may provide technical benefits independently when implemented in isolation, any combination of these procedures may be implemented together.

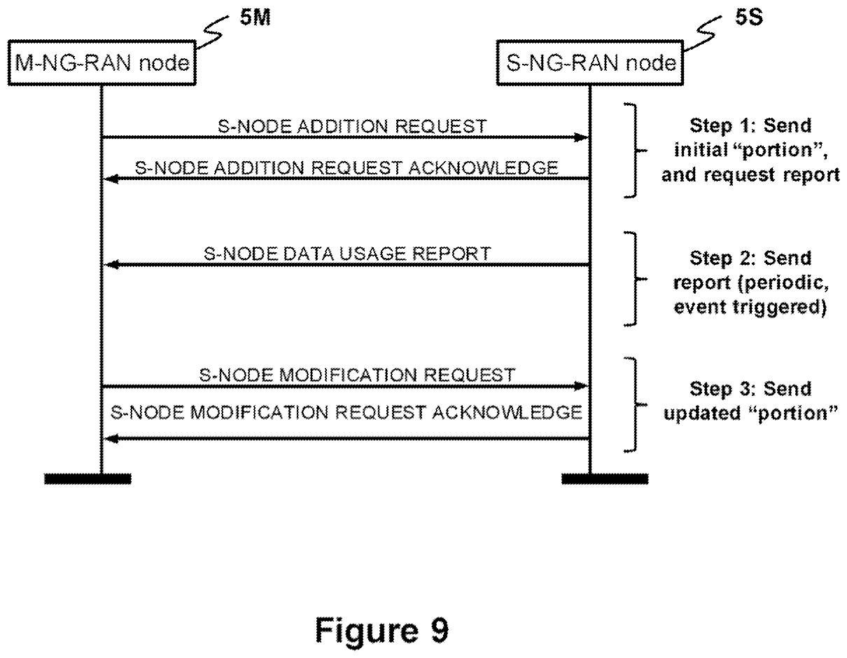

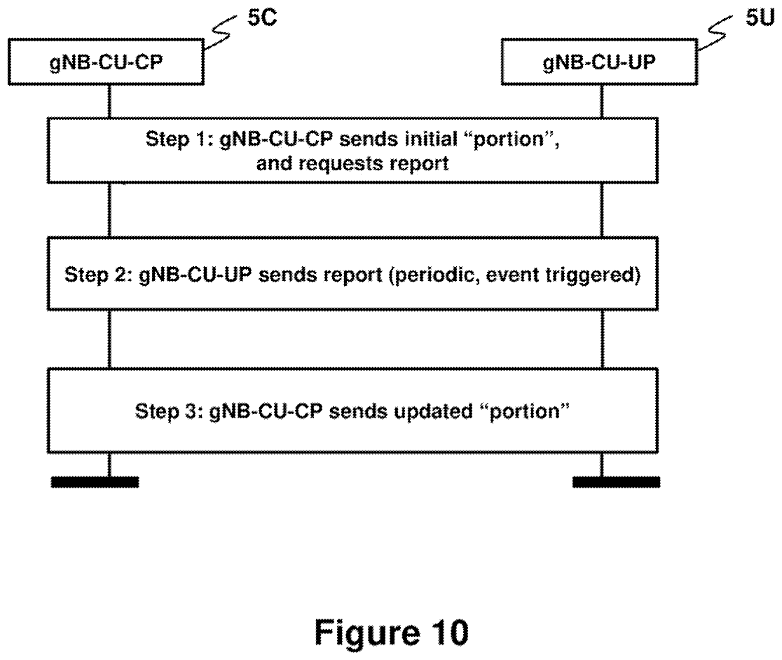

A more detailed description of some exemplary embodiments is provided below with reference to FIGS. 9 and 10. Specifically, FIG. 9 illustrates schematically an exemplary embodiment for managing and enforcing an associated portion of the integrity protected data rate for a UE 3 when the UE 3 is served by an MN 5M and an SN 5S. FIG. 10 illustrates schematically an exemplary embodiment for managing and enforcing an associated portion of the integrity protected data rate for a UE 3 when the UE 3 is served by (multiple units of) a distributed base station 5.

In the following exemplary embodiments, the term “portion” refers to a portion of a UE specific maximum data rate to be enforced at a node for integrity protected DRBs terminated at that node. The “portion” is effectively a (hard) limit for the UE's maximum data rate for integrity protected traffic on SN terminated PDU sessions (at least one PDU session).

Inter-Node Interaction Between gNB-MN and gNB-SN

FIG. 9 illustrates schematically an exemplary embodiment for managing and enforcing an associated portion of the integrity protected data rate for a UE 3 when the UE 3 is served by an MN 5M and an SN 5S. It will be appreciated that the procedure may include additional steps which are omitted for brevity.

### First Exemplary Embodiment

Step 1: the MN 5M requests, from the SN 5S, information relating to the UE's DRBs terminated at the SN 5S. For example, the MN 5M may request (by an appropriately formatted ‘Report Characteristics’ field) a data usage report for the UE 3 on all associated integrity protected bearers terminated by the SN 5S (for the UE's downlink and/or uplink traffic). The MN 5M includes in its request an appropriately formatted information element (e.g. an “S-NG-RAN node Report Characteristics” IE and/or the like). As shown in Step 1 of FIG. 9, the request in this example comprises an ‘S-NODE ADDITION REQUEST’ message, although any suitable message may be used.

The MN 5M indicates the type of reporting required from the SN 5S using an appropriately formatted information element (e.g. an “S-NG-RAN node Reporting Type” IE and/or the like). The information element may also specify whether the SN 5S needs to report back to the MN 5M periodically, when triggered by an event, and/or on demand. The periodicity of reporting may be indicated via an appropriately formatted information element (e.g. an ‘S-NG-RAN node Reporting Periodicity’ IE and/or the like). It will be appreciated that the above described IEs may be included in the same message (the same S-NODE ADDITION REQUEST message), as shown in Table 1. Table 2 illustrates some of the fields of an appropriate acknowledgement message (e.g. an S-NODE ADDITION REQUEST ACKNOWLEDGE message) sent from the SN 5S to the MN 5M to indicate whether the SN 5S is able to generate the requested report.

TABLE 1
S-NODE ADDITION REQUEST

| | | | IE type and | |
|---|---|---|---|---|
| IE/Group Name | Presence | Range | reference | Semantcs description |
| . . . | . . . | . . . | . . . | . . . |
| S-NG-RAN | O | | ENUMERATED | This IE indicates the request from the M-NG- |
| node Report | | | (IP Data Rate | RAN node to S-NG-RAN node to provide the |
| Characteristics | | | DL, IP Data | aggregate integrity protected data rate |
| | | | Rate UL, . . . ) | downlink or uplink on all DRBs in SN |
| | | | | terminated PDU sessions. |
| S-NG-RAN | O | | BITSTRING | First Bit = Periodic Reporting, |
| node Reporting | | | (SIZE(8)) | Second Bit = Event Trigger Reporting, |
| Type | | | | Third Bit = on demand Reporting, |
| | | | | Other bits shall be ignored by the S-NG-RAN |
| S-NG-RAN | O | | INTEGER | |
| node Reporting | | | (1 . . . 60, . . . ) | |
| Periodicity | | | | |

TABLE 2
S-NODE ADDITION REQUEST ACKNOWLEDGE

| | | | IE type and | |
|---|---|---|---|---|
| IE/Group Name | Presence | Range | reference | Semantic description |
| . . . | . . . | . . . | . . . | . . . |
| S-NG-RAN | O | | ENUMERATED | This IE indicates whether the S-NG-RAN node |
| node Report | | | (reportSuccess, | is able to generate the requested Report |
| Acknowledge | | | reportFailure, . . . ) | Characteristics or not. |
| | | | | “reportSuccess” indicates that the S-NG-RAN |
| | | | | will send the report to M-NG-RAN. |
| | | | | “reportFailure” indicates that the S-NG-RAN |
| | | | | will not send the report to M-NG-RAN. |

If the SN 5S is not able to provide the requested report, it informs the MN 5M using an appropriately formatted information element (e.g. an ‘S-NG-RAN node Report Acknowledge’ IE and/or the like) included in the S-NODE ADDITION REQUEST ACKNOWLEDGE message and the procedure ends.

However, if the SN 5S is able to provide the requested report, it informs the MN 5M (by setting the information element in the S-NODE ADDITION REQUEST ACKNOWLEDGE message accordingly) and proceeds to the next step.

Step 2: The SN 5S monitors (e.g. over a given time period y) integrity protected traffic on the UE's PDU sessions (downlink and/or uplink traffic) terminated at the SN 5S, and generates a report (depending on the request received from the MN 5M in Step 1). In this example, the SN 5S sends the requested report in an appropriately formatted ‘S-NODE DATA USAGE REPORT’ message and/or the like. An example of the contents of this message is given in Table 3.

TABLE 3
S-NG-RAN DATA USAGE REPORT

| | | | IE type and | |
|---|---|---|---|---|
| IE/Group Name | Presence | Range | reference | Semantics description |
| Message Type | M | | | |
| M-NG-RAN node UE | M | | NG-RAN node | Allocated at the M-NG-RAN |
| XnAP ID | | | UE XnAP ID | node |
| S-NG-RAN node UE | M | | NG-RAN node | Allocated at the S-NG-RAN |
| XnAP ID | | | UE XnAP ID | node |
| PDU Session Usage | | 1 | | |
| Report List | | | | |
| >PDU Session Usage | | 1 . . . | | |
| Repot Item | | <maxnoofPDUSessionResource> | | |
| >> PDU Session ID | M | | | |
| >>>PDU Session | O | | Bit Rate | This IE indicates the IP DL |
| DL Aggregate IP | | | | data rate on all DRBs in the |
| Data Rate | | | | PDU session. |
| >>>PDU Session | O | | Bit Rate | This IE indicates the IP UL |
| UL Aggregate IP | | | | data rate on all DRBs in the |
| Data Rate | | | | PDU session. |

This message is sent by the S-NG-RAN node (SN 5S) to provide UE-associated information to the M-NG-RAN (MN 5M).

In the case of event triggered reporting, the SN 5S sends its report to MN 5M when the measured aggregate integrity protected data rate on SN terminated PDU sessions (DL or UL) exceeds the associated “portion”.

Step 3: The MN 5M checks whether the reported aggregate integrity protected data rate on downlink or uplink traffic on the PDU sessions terminated at the SN 5S exceeds the value of the “portion” for that SN 5S (i.e. the initial value configured in Step 1).

If the reported aggregate integrity protected data rate exceeds the associated portion, the nodes may be configured to perform one of the following options:

Option 1 (MN-initiated modification): the MN 5M requests the SN 5S to modify or release PDU Session Resources allocated to the UE 3 on Integrity Protected DRBs (SN terminated DRBs). For example, the MN 5M may send an appropriately formatted S-NODE MODIFICATION REQUEST message to the SN 5S. This will allow the SN 5S to adjust the UE integrity protected downlink or uplink traffic on SN terminated PDU sessions.

Option 2 (SN-initiated modification): The SN 5S requests permission from the MN 5M to modify or release resources allocated to the UE 3 on Integrity Protected DRBs (SN terminated DRBs). For example, the SN 5S may send an appropriately formatted S-NODE MODIFICATION REQUIRED message to the MN 5M. When the MN 5M responds to the SN 5S confirming that the requested change is allowed, the SN 5S is able to adjust the UE integrity protected downlink or uplink traffic on SN terminated PDU sessions.

Option 3: The MN 5M decides to increase the “portion” applicable to the SN 5S and sends an updated value to the SN 5S (e.g. using an appropriately formatted S-NODE MODIFICATION REQUEST message).

Option 4: The SN 5S requests the MN 5M to increase its “portion”. In this case, the SN 5S may request a specific portion value that is more suitable to its local traffic condition and resource status. Alternatively, the SN 5S may indicate (e.g. using one bit) that an increased value is desired for its “portion” (without specifying any specific value).

It will be appreciated that the nodes may be configured to perform one of the above options (or similar procedures) even if the reported aggregate integrity protected data rate does not exceed the associated portion. For example, the MN 5M may be configured to adjust the portion applicable to the SN 5S periodically, adjust the portion when the number of SN changes (e.g. when an SN is added for the UE 3 or when an earlier SN is no longer serving the UE 3), and/or adjust the portion when the reported aggregate integrity protected data rate is below (or above) an associated threshold.

It will also be appreciated that the SN 5S may be configured to reject establishment of the PDU session(s) if it cannot support its associated portion of the UE Max IP data rate (signalled in Step 1). In this case, for example, the SN 5S may be configured to respond to the MN 5M with an appropriately formatted S-NODE ADDITION REQUEST ACKNOWLEDGE message or an appropriately formatted S-NODE MODIFICATION REQUEST ACKNOWLEDGE message (depending on the message received in Step 1).

If the S-NODE ADDITION REQUEST message (in Step 1) contains the S-NG-RAN node Maximum Integrity Protected Data Rate IE, and the S-NG-RAN node (SN 5S) cannot comply with this maximum data rate, then the S-NG-RAN node may reject the establishment of the UE's SN terminated PDU Sessions and it will include these failed PDU sessions in an appropriate information element of the response. For example, an appropriately formatted ‘PDU Session Resources Not Admitted List—SN terminated’ IE may be used (with appropriate cause value).

If the S-NODE MODIFICATION REQUEST message (in Step 1) contains the S-NG-RAN node Maximum Integrity Protected Data Rate IE, and the S-NG-RAN node (SN 5S) cannot comply with this maximum data rate, then the S-NG-RAN node may reject the establishment or modification of the UE's SN terminated PDU Sessions and it will include these failed PDU sessions in an appropriate information element of the response. For example, an appropriately formatted ‘PDU Session Resources Not Admitted to be Added List’ IE may be used (with appropriate cause value).

### Second Exemplary Embodiment

It will be appreciated that the UPF 11 may obtain the value of the “maximum supported data rate per UE for integrity protection for all DRBs” from the SMF 13. The UPF 11 may be configured to monitor the data rate for all integrity protected (IP) PDU sessions. When the UPF 11 detects that the total integrity protected UP traffic on all PDU sessions is almost reaching a certain level (e.g. the maximum supported data rate per UE for integrity protection for all DRBs), then the UPF 11 can provide appropriate assistance information (e.g. a warning message) to the NG-RAN indicating that the total IP traffic is approaching the maximum supported data rate per UE for integrity protection for all DRBs.

Upon receipt of the assistance information from the UPF 11, the MN 5M requests the SN 5S to provide the total data rate on all integrity protected PDU sessions (for SN terminated DRBs). The MN 5M also obtains its own total data rate on all integrity protected PDU sessions for any MN terminated DRBs.

The MN 5M then checks whether the SN-terminated and/or MN-terminated integrity protected PDU sessions has exceeded the part of the maximum supported data rate per UE for integrity protection for all DRBs.

If the SN-terminated PDU sessions exceed the allocated limit (“portion”) then the MN 5M can take appropriate action, for example: (a) temporary drop the SN 5S; or (b) change the bearer type from SN-terminated to MN-terminated bearer.

If the MN-terminated PDU sessions exceed the allocated part of the maximum supported data rate per UE for integrity protection for all DRBs, then the MN 5M may be configured to modify or drop one or more of its own (MN-terminated) DRBs of the PDU session.

Intra-Node Interaction Between CU-CP and CU-UP

### Third Exemplary Embodiment

This exemplary embodiment is applicable to intra-node interactions (between the CU-CP and CU-UP parts of a distributed base station 5) in the system 1c shown in FIG. 4. FIG. 5 illustrates schematically an exemplary way in which a distributed base station may be configured to act as a secondary node 5S, employing a plurality of CU-UP parts.

Step1: the MN 5M (in this case, a base station 5 acting as the master node) assigns an appropriate portion to the SN 5S (which may be separated into one CP 5C part and multiple UP 5U parts, for handling the UE's control plane and user plane, respectively). As explained above, the portion refers to the maximum integrity protected aggregate data rate allowed on all integrity protected PDU sessions (for SN terminated DRBs). The aggregate integrity protected data rate includes rates of guaranteed bit rate (GBR), non-GBR, or both GBR and non-GBR quality of service (QoS) flows.

Step2: the CP 5C allocates appropriate sub-portions to all its UPs 5U (forming the SN 5S) such that the sum of the sub-portions is less than or equal to the value of the SN specific portion received from the MN 5M.

Step3: Each UP 5U starts monitoring its aggregate integrity protected data rate over a time period x (which may be a predetermined/default period, or a period set by the MN 5M).

If the monitored aggregate integrity protected data rate at a given UP_i exceeds its sub-portion value, for the time period x, then that UP_i shall request a larger sub-portion from the CP 5C. In turn, the CP 5C performs at least one of the following checks:
if the sum (of all sub-portions) is less than the SN portion, then the CP 5C increases the sub-portion_i for UP_i (preferably without changing the respective sub-portions for other UPs or without changing the sum thereof); and
if the sum (of all sub-portions) is equal to the SN portion, then the CP 5C may perform one of the following options:
   Option 1: the CP 5C (1) reduces sub-portion(s) of other UP(s), (2) increases the sub-portion_i, while keeping sum (sub-portions)≤portion, and (3) informs each UP of their new sub-portion(s) (at least those UPs with changed sub-portion).
   Option 2: the CP 5C (1) requests a new larger portion value from the MN 5M, then (2) updates the sub-portion_i, while keeping sum (sub-portions)≤new portion.
   Option 3: the CP 5C (or UP_i) initiates modification or removal of one or more integrity protected DRBs (e.g. starting with less important DRBs), in order to reduce the aggregate integrity protected data rate below the sub-portion_i (e.g. on downlink). This action can be initiated by CP/UP (e.g. using an appropriate BEARER CONTEXT MODIFICATION REQUEST/REQUIRED message and/or the like).
   Option 4: the nodes release all related signalling and user data transport resources on UP_i. This action can be initiated by CP/UP (e.g. using an appropriate BEARER CONTEXT RELEASE COMMAND/REQUEST message and/or the like).

### Fourth Exemplary Embodiment

Steps 1 and 2 of this exemplary embodiment are the same as Steps 1 and 2 of the third exemplary embodiment.

Step3: Each UP 5U starts monitoring its aggregate integrity protected data rate over a time period x (as above).

If the monitored aggregate integrity protected data rate at a given UP_i is within an offset value from the corresponding sub-portion_i, for the time period x, then that UP_i may be configured to request a larger sub-portion from the CP 5C. For example, the offset value may be measured in data rate, and may be based on: (1) UP local condition (resources, transmission buffer status, channel condition, load, etc.) and (2) service requirements on the UP (e.g. low latency requirements—online video gaming).

When the UP_i requests a larger sub-portion from the CP 5C, the CP 5C performs one or both of the following checks:
if the sum (of all sub-portions) is less than the SN portion, then the CP 5C increases the sub-portion_i for UP_i (preferably without changing the respective sub-portions for other UPs or without changing the sum thereof); and
if the sum (of all sub-portions) is equal to the SN portion, then the CP 5C may perform one of Options 1 to 4 described above.

Intra-Node and Intra-Node Interaction: Between gNB-MN and gNB-SN/Between CU-CP and CU-UP

### Fifth Exemplary Embodiment

This exemplary embodiment may be applicable to the exemplary architecture shown in FIGS. 4 and 5.

Step1: the 5G core network 7 (e.g. SMF/AMF) notifies the MN 5 about the applicable integrity protected data rate, for example by sending an appropriately formatted information element (a “PDU Session Integrity Protected Maximum Data Rate” IE and/or the like). This information element may be included for example in a ‘PDU Session Resource Setup Request Transfer’ IE (or similar), in a ‘PDU SESSION RESOURCE SETUP REQUEST’ message (from the AMF to the MN 5M). Examples of the contents of the ‘PDU Session Resource Setup Request Transfer’ IE are given in Tables 4 to 6.

In this example, the PDU Session Integrity Protected Maximum Data Rate IE is used, which defines the maximum Integrity Protected Data Rate allowed for all integrity protected DRBs per PDU session, for a given UE. It will be appreciated that another suitable information element may be used, if appropriate. The information element in this example also includes a ‘PDU Session Integrity Protected Maximum Data Rate Downlink’ IE, and a ‘PDU Session Integrity Protected Maximum Data Rate Uplink’ IE, for specifying the integrity protected data rate applicable to the UE's downlink and uplink DRBs, respectively. Table 7 illustrates an example of the above mentioned information elements.

Step2: the MN 5M sends (forwards) the PDU Session Integrity Protected Maximum Data Rate IE to the SN 5S (e.g. included in an ‘S-NODE ADDITION REQUEST’ message or similar).

Step3: the CU-CP 5C (‘gNB-SN-CP’) sends the PDU Session Integrity Protected Maximum Data Rate IE to the CU-UP 5U (‘gNB-SN-UP’) (e.g. included in a ‘BEARER CONTEXT SETUP REQUEST’ message or similar) to be used by the CU-UP 5U for policing integrity protected traffic for a given PDU session. If there are more than one CU-UPs 5U, the CU-CP 5C sends the PDU Session Integrity Protected Maximum Data Rate IE to each CU-UP 5U.

Step4: Each CU-UP 5U starts to monitor the aggregate integrity protected data rate on DL traffic or UL traffic for all DRBs of a PDU session, over a time period x.

If the aggregate integrity protected DL data rate is larger than the PDU Session Integrity Protected Maximum Data Rate Downlink, or the aggregate integrity protected UL data rate is larger than the PDU Session Integrity Protected Maximum Data Rate Uplink, then the CU-UP 5U enforces the PDU Session Integrity Protected Maximum Data Rate Downlink and/or PDU Session Integrity Protected Maximum Data Rate Uplink using one of the following mechanisms:

Option 1: the CU-UP 5U modifies or removes integrity protected downlink/uplink DRBs in the PDU session (e.g. modifies/removes resources allocated to the DRBs/QoS flows according to their associated priority levels, pre-emption capability, etc.). In order to reduce the aggregate integrity protected data rate on DL/UL traffic, the CU-UP 5U informs the CU-CP 5C of the reason for modifying or removing DBRs using, for example, via an appropriate cause value (e.g. “PDU Session maximum integrity protected DL data rate reason” or “PDU Session maximum integrity protected UL data rate reason”). Thus, effectively, in this option the CU-UP 5U asks the CU-CP 5C to allow modification or removal of DRBs (using an appropriate message e.g. a Bearer Context Modification Required message) before proceeding to the modification or removal of the DRBs. The above mentioned cause value may be provided, for example, using an appropriate ‘Cause’ information element as shown in Table 8.

Option 2: the CN-UP 5U informs the CN-CP 5C that the integrity protected DL traffic or the integrity protected UL traffic exceeds the associated PDU Session Integrity Protected Maximum Data Rate Downlink or PDU Session Integrity Protected Maximum Data Rate Uplink, using an appropriate information element (for example, a “PDU Maximum IP Data Rate DL Report” IE, a “PDU Maximum IP Data Rate UL Report” IE, and/or the like). For example, the CU-UP 5U may include the PDU Maximum IP Data Rate DL Report IE or PDU Maximum IP Data Rate UL Report IE in the Data Usage Report List IE included in a DATA USAGE REPORT message (from the CU-UP to the CU-CP). Based on data usage report of all DRBs, the CU-CP 5C requests the CU-UP 5C to modify or remove some DRBs (at least one DRB) in order to reduce the integrity protected traffic at the CU-UP 5U. Thus, effectively, in this option the CU-CP 5C asks the CU-UP 5U to modify or remove DRBs using an appropriate formatted BEARER CONTEXT MODIFICATION REQUEST message or similar. Examples of the contents of the DATA USAGE REPORT message and the Data Usage Report List information element are given in Tables 9 and 10.

TABLE 4
PDU Session Resource Setup Request Transfer

| | | | IE type and | |
|---|---|---|---|---|
| IE/Group Name | Presence | Range | reference | Semantics description |
| PDU Session | O | | 9.3.1.102 | This IE shall be present when at least |
| Aggregate Maximum | | | | one non-GBR QoS flow is being setup. |
| Bit Rate | | | | |
| PDU Session | O | | 9.3.1.xxx | This IE shall be present when least |
| Integrity Protected | | | | one Integrity Protected PDU session is |
| Maximum Data Rate | | | | being setup. |
| UL NG-U UP TNL | M | | UP Transport | UPF endpoint of the NG-U transport |
| information | | | Layer Information | bearer, for delivery of UL PDUs. |
| | | | 9.3.2.2 | |
| Additional UL NG-U | O | | UP Transport | UPF endpoint of the additional NG-U |
| UP TNL Information | | | Layer Information | transport bearer, for delivery of UL |
| | | | 9.3.2.2 | PDUs. |
| Data Forwarding Not | O | | 9.3.1.63 | This IE may be present in case of |
| Possible | | | | HANDOVER REQUEST message and |
| | | | | shall be ignored otherwise. |
| PDU Session Type | M | | 9.3.1.52 | |
| Security Indication | O | | 9.3.1.27 | |
| Network Instance | O | | 9.3.1.113 | |
| Qos Flow Setup | | 1 | | |
| Request List | | | | |
| >QoS Flow Setup | | 1 . . . | | |
| Request Item | | <maxnoofQoSFlows> | | |
| >>QoS Flow | M | | 9.3.1.51 | |
| Identifier | | | | |
| >>QoS Flow Level | M | | 9.3.1.12 | |
| QoS Parameters | | | | |
| >>E-RAB ID | O | | 9.3.2.3 | |

The above information element is transparent to the AMF. Note: in this example the PDU Session Integrity Protected Maximum Data Rate IE is “Optional”.

TABLE 5
PDU Session Resource Setup Request Transfer

| | | | IE type and | |
|---|---|---|---|---|
| IE/Group Name | Presence | Range | reference | Semantics description |
| PDU session | O | | 9.3.1.102 | This IE shall be present when at least |
| Aggregate Maximum | | | | one non-GBR QoS flow is being . |
| Bit Rate | | | | setup |
| PDU Session | C-if | | 9.3.1.xxx | This IE shall be present when at least |
| Integrity Protected | Integrity | | | one Integrity Protected PDU session |
| Maximum Data Rate | Protection | | | is being setup. |
| | Requiredor | | | |
| | Preferred | | | |
| UL NG-U UP TNL | M | | UP Transport | UPF endpoint of the NG-U transport |
| Information | | | Layer | bearer, for delivery of UL PDUs. |
| | | | Information | |
| | | | 9.3.2.2 | |
| Additional UL NG-U | O | | UP Transport | UPF endpoint of the additional NG-U |
| UP TNL Information | | | Layer | transport bearer, for delivery of UL |
| | | | Information | PDUs. |
| | | | 9.3.2.2 | |
| Data Forwarding Not | O | | 9.3.1.63 | This IE may be present in case of |
| Possible | | | | HANDOVER REQUEST message |
| | | | | and shall be ignored otherwise. |
| PDU Session Type | M | | 9.3.1.52 | |
| Security Indication | O | | 9.3.1.27 | |
| Network Instance | O | | 9.3.1.113 | |
| QoS Flow Setup | | 1 | | |
| Request List | | | | |
| >QoS Flow Setup | | 1 . . . | | |
| Request Item | | <maxnoofQoSFlows> | | |
| >>QoS Flow | M | | 9.3.1.51 | |
| Identifier | | | | |
| >QoS Flow Level | M | | 9.3.1.12 | |
| QoS Parameters | | | | |
| >>E-RAB ID | O | | 9.3.2.3 | |

| Condition | Explanation |
|---|---|
| IfIntegrityProtectionRequiredorPreferred | This IE shall be present if the Integrity Protection Indication IE |
| | within the Security Indication IE is present and set to “required” |
| | or “preferred”. |

The above information element is transparent to the AMF. Note: in this example the PDU Session Integrity Protected Maximum Data Rate IE is “Conditional”.

TABLE 6
PDU Session Resource Modify Request Transfer

| | | | IE type and | |
|---|---|---|---|---|
| IE/Group Name | Presence | Range | reference | Semantics description |
| PDU Session | O | | 9.3.1.102 | |
| Aggregate | | | | |
| Maximum Bit Rate | | | | |
| PDU Session | O | | 9.3.1.xxx | This IE shall be present when at least |
| Integrity Protected | | | | one Integrity Protected PDU session |
| Maximum Data Rate | | | | is being modified. |
| UL NG-U UP TNL | | 0 . . . 1 | | |
| Modify List | | | | |
| >UL NG-U UP TNL | | 1 . . . | | |
| Modify Item | | <maxnoofMutiConnectivities> | | |
| >>UL NG-U UP | M | | UP Transport | UPF endpoint of the NG-U transport |
| TNL Information | | | Layer Information | bearer, for dehiery of UL PDUs. |
| | | | 9.3.2.2 | |
| >DL NG-U UP | M | | UP Transport | Identifies the NG-U transport bearer |
| TNL Information | | | Layer Information | at the NG-RAN node. |
| | | | 9.3.2.2 | |
| Network Instance | O | | 9.3.1.113 | |
| QoS Flow Add or | | 0 . . . 1 | | |
| Modify Request List | | | | |
| >QoS Flow Add or | | 1 . . . <maxnoofQoSFlows> | | |
| Modify Request Item | | | | |
| >>QoS Flow | M | | 9.3.1.51 | |
| Identifier | | | | |
| >>QoS Flow Level | O | | 93.1.12 | |
| QoS Parameters | | | | |
| >>E-RAB ID | O | | 9.3.2.3 | |
| QoS Flow to | O | | QoS Flow List | |
| Release List | | | 9.3.1.13 | |
| Additional UL NG-U | O | | UP Transport | UPF endpoint of the additional NG-U |
| UP TNL Information | | | Layer Information | transport bearer proposed for delivery |
| | | | 9.3.2.2 | of UL PDUs for split PDU session. |

The above information element is transparent to the AMF.

TABLE 7
PDU Session Maximum Integrity Protected Data Rate

| | | | IE type and | |
|---|---|---|---|---|
| IE/Group Name | Presence | Range | reference | Senantics description |
| PDU Session | | 1 | | Applicable for Integrity Protected DRBs |
| Integrity Protected | | | | |
| Maximum Data Rate | | | | |
| >PDU Session | M | | Bit Rate | Indicates the PDU session Maximum Integrity |
| Integrity Protected | | | 9.3.1.4 | Protected Data Rate in the downlink direction. |
| Maximum Data Rate | | | | |
| Downlink | | | | |
| >PDU Session | M | | Bit Rate | Indicates the PDU session Maximum Integrity |
| Integrity Protected | | | 9.3.1.4 | Protected Data Rate in the uplink direction. |
| Maximum Data Rate | | | | |
| Uplink | | | | |

The above information element is applicable for all integrity protected DRBs per PDU session which is defined for the downlink and the uplink direction and is provided by the SMF 12 to the NG-RAN node (base station 5/MN 5M).

TABLE 8
Cause

| | | | | Semantics |
|---|---|---|---|---|
| IE/Group Name | Presence | Range | IE type and reference | description |
| CHOICE Cause Group | M | | | |
| >Radio Network Layer | | | | |
| >>Radio Network | M | | ENUMERATED | |
| Layer Cause | | | (Unspecified, | |
| | | | . . . | |
| | | | Encryption algorithms not supported, | |
| | | | Itegrity protection algorithms not supported, | |
| | | | UP integrity protection not possible, | |
| | | | UP confidentiality protection not possible, | |
| | | | . . . | |
| | | | PDCP configuration not supported, | |
| | | | PDU Session maximum integrity protected | |
| | | | data rate downlink reason, | |
| | | | PDU Session maximum integrity protected | |
| | | | data rate uplink reason | |
| | | | . . . ) | |
| >Transport Layer | | | | |
| . . . | . . . | . . . | . . . | . . . |

| Radio Network Layer cause | Meaning |
|---|---|
| PDCP configuration not supported | The gNB-CU-UP is unable to support the selected PDCP |
| | configuration for the UE. |
| PDU Session maximum integrity | The PDU Session maximum integrity protected data rate |
| protected data rate downlink reason | downlink is exceeded. |
| PDU Session maximum integrity | The PDU Session maximum integrity protected data rate |
| protected data rate upink reason | uplink is exceeded. |

The purpose of the Cause information element is to indicate the reason for a particular event for the E1AP protocol.

TABLE 9
DATA USAGE REPORT

| | | | IE type and | Semantics |
|---|---|---|---|---|
| IE/Group Name | Presence | Range | reference | description |
| Message Type | M | | 9.3.1.1 | |
| gNB-CU-CP UE E1AP ID | M | | 9.3.1.4 | |
| gNB-CU-UP UE E1AP ID | M | | 9.3.1.5 | |
| Data Usage Report List | M | | 9.3.1.44 | |

This message is sent by the CU-UP 5U to the CU-OP 5U to report data volumes.

TABLE 10
Data Usage Report List

| | | | IE type and | |
|---|---|---|---|---|
| IE/Group Name | Presence | Range | reference | Semantics description |
| Data usage | | 1 . . . | | |
| report Item | | <maxnoofDRBs> | | |
| PDU Maximum | O | | ENUMERATED | This IE indicates to the gNB-CU- |
| IP Data Rate | | | (exceeded, not | UP that the PDU session |
| Report DL | | | exeeded, . . . ) | maximum Integrity Protected Data |
| | | | | Rate Downlink is exceeded or not |
| PDU Maximum | O | | ENUMERATED | This IE indicates to the gNB-CU- |
| IP Data Rate | | | (exceeded, not | UP that the PDU session |
| Report UL | | | exceeded, . . . ) | maximum Integrity Protected Data |
| | | | | Rate Uplink is exceeded or not |
| >DRB ID | M | | 9.3.1.16 | |
| >RAT Type | M | | ENUMERATED | |
| | | | (NR, . . . ) | |
| >DRB Usage | | 1 | | |
| Report List | | | | |
| >>DRB Usage | | 1 . . . | | |
| Report Item | | <maxnooftimeperiods> | | |
| . . . | . . . | . . . | . . . | . . . |

| Range bound | Explanation |
|---|---|
| maxnoofDRBs | Maximum no. of DRBs. Value is 32. |
| Maxnooftimeperiods | Maximum no. of time reporting periods. Value is 2. |

This information element provides information on the data usage for the UE 3.

PDU Session Split at UPF

### Sixth Exemplary Embodiment

This exemplary embodiment concerns a scenario in which a PDU session is split at the UPF 11 during PDU Session Resource Setup or PDU Session Resource Modify.

For this case, the enforcement of maximum integrity protected data rate for the split PDU session requires assistance information from the core network 7 (the UPF 11) which is aware of associated packet QoS parameters and the data rate for the PDU Session.

Step 1: the core network 7 (AMF/SMF) signals to the MN 5M (e.g. in the PDU Session Resource Setup Request Transfer IE, in the PDU SESSION RESOURCE SETUP REQUEST message sent from the AMF to the MN 5M) the following:
(an information element specifying) a PDF Session level Max IP data rate
(an information element specifying) a DRB level Max IP data rate
(an information element specifying) a QoS Flow level Max IP data rate

Step 2: the MN 5M signals (forwards) the received information (IEs) to the SN 5S (e.g. using an appropriately formatted S-NODE ADDITION REQUEST message).

Step 3: the CU-CP 5C part of the SN 5S forwards the information to the CU-UP 5U (e.g. using an appropriately formatted BEARER CONTEXT SETUP REQUEST message). The information is then used by the CU-UP 5U for policing integrity protected traffic on all its DRBs.

As a way of a specific example, a PDU session may be split at the UPF 11 to two QoS flows, which are forwarded to two different CU-UPs 5U (via the MN 5). Each CU-UP 5U starts monitoring its own (portion of the) integrity protected data rate on QoS level, over a time period z. If the integrity protected data rate per QoS flow exceeds the QoS Flow level maximum integrity protected data rate at one of the CU-UPs 5U, then that CU-UP 5U will inform the CU-CP 5C about this. In this case, the CU-CP 5C may be configured to e.g.: (a) temporarily drop the CU-UP 5U; or (b) request the CU-UP 5U to reduce the data rate of the considered QoS flow (to less than or equal to QoS Flow level maximum integrity protected data rate or the applicable portion/sub-portion thereof).

Intra-Node Interaction Between CU-CP and CU-UPs

### Seventh Exemplary Embodiment

In this exemplary embodiment, the CU-CP 5C is configured to request an appropriate report (via a Report Characteristics IE and/or the like) from all connected CU-UPs 5U (as shown in FIG. 5).

Step 1: the CU-CP 5C divides the maximum integrity protected data rate portion (assigned to the SN 5S to which the CU-CP 5C belongs) into the multiple respective sub-portions for multiple CU-UPs 5U. For example, the CU-CP 5C may be configured to use the formula:

Portion_SN & sum≥(Portion_1, . . . ,Portion_N)

Step 2: the CU-CP 5C includes an appropriate information element (e.g. a “UP Report Characteristics” IE) in the BEARER CONTEXT SETUP REQUEST message to request the CU-UP 5U to send its report to the CU-CP 5C (a report on data usage on integrity protected DRBs—downlink/uplink traffic). The CU-CP 5C indicates in its request whether the CU-UP 5U should provide the report periodically or as event triggered. The periodicity of reporting may be indicated via a suitable information element (e.g. a ‘UP Reporting Periodicity’ IE and/or the like).

Step 3: the CU-UP 5U indicates to the CU-CP 5C whether or not it can provide the requested report using an appropriate information element (e.g. a “UP Report Acknowledge” IE and/or the like) in its response to the CU-CP 5C (e.g. a BEARER CONTEXT SETUP RESPONSE message or similar).

Step 4: each CU-UP 5U monitors (over a given time period y) integrity protected traffic on its DRBs (DL and/or UL) and generates the report as requested (periodically or when triggered by an event).

Step 5: The CU-UP 5U sends the requested report in an appropriate message to the CU-CP 5C (e.g. a ‘UP DATA USAGE REPORT’ message or similar).

Step 6: Based on the report(s) from the CU-UP(s) 5U, the CU-CP 5C may proceed to update the initial values of Portion_1, Portion_2, . . . , such that the maximum integrity protected data rate portion (in Step 1) is not exceeded. The updated values are sent to CU-UPs 5U, for example using the BEARER CONTEXT MODIFICATION REQUEST message (and/or the like).

It will be appreciated that a CU-UP 5U may be configured to send its report (e.g. UP DATA USAGE REPORT message) as event triggered. In this case, when the aggregate UE integrity protected data rate (DL/UL) at CU-UP_i exceeds its allowed “portion_i”, the CU-CP 5C may assign a new (higher) value to the “portion_i” for that CU-UP_i and include the new value in an appropriate message (e.g. the BEARER CONTEXT MODIFICATION REQUEST message or similar). Alternatively, the CU-CP 5C may request the CU-UP_i to modify resources allocated to the PDU sessions (or DRBs, QoS Flows) at the CU-UP_i, in order to adjust the integrity protected user plane traffic at the concerned CU-UP_i.

When the aggregate UE integrity protected data rate (DL/UL) at the CU-UP 5U goes below an appropriate minimum threshold value for integrity protected data rate (required for a given service/application), the CU-CP 5C may be configured to request that CU-UP 5U to modify resources for PDU sessions (DRBs, QoS Flows) in order to adjust the integrity protected UP traffic at the CU-UP side.

It will be appreciated that the CU-CP 5C may decide not to update the “portions” for all CU-UPs, but to change the “portions” values only for those CU-UPs that triggered a report. However, even in this case the CU-CP 5C needs to ensure that the sum of all portions remains the same as (or becomes less than) the sum before updating the values. For example, the CU-CP 5C may use the following formula (where * denotes an updated value):

Portion_SN≥sum(Portion_1*,Portion_2*, . . . ,Portion_N)

By way of a specific example, the CU-CP 5C may update values of Portion_1 and Portion_2 for CU-UP_1 and CU-UP_2, respectively (i.e. the CU-UPs that sent reports). In this case, the CU-CP 5C may perform the following updates:
i) Portion_1<Portion_1*
   (updated value based on report from CU-UP_1 that Portion_1 is too high)
ii) Portion_2>Portion_2*
   (updated value based on report from CU-UP_2 that Portion_2 is too low)
iii) leave values of Portion_3 to Portion_N (for CU-UP_3 to CU-UP_N) unchanged.

It will be appreciated that in this example the CU-CP 5C effectively re-allocates a part of Portion_1 to Portion_2 so that the value of Portion_SN does not increase as a result if the updates (i.e. the decrease in the value of Portion_1 corresponds to the increase in the value of Portion_2, but in any case the decrease in the value of Portion_1 is larger than the increase in the value of Portion_2).

Modifications and Alternatives

Detailed exemplary embodiments have been described above. As those skilled in the art will appreciate, a number of modifications and alternatives can be made to the above exemplary embodiments whilst still benefiting from the inventions embodied therein. By way of illustration only a number of these alternatives and modifications will now be described.

It will be appreciated that the above exemplary embodiments may be applied to both 5G New Radio and LTE systems (Evolved Universal Terrestrial Radio Access Network, ‘E-UTRAN’).

It will be appreciated that whilst, in the above examples, a ‘gNB’ type base station is described, much of the functionality can be extended to other base stations (e.g. eNBs, ng-eNBs, En-gNBs, NG-RAN nodes) or similar apparatus for providing radio access to UEs such as mobile (cellular) telephones/smartphones, MTC/IoT devices, and/or other mobile or fixed location communication devices. Although not shown in FIGS. 1 to 4, the base station may also control one or more associated cells either directly or via other nodes such as home base stations, relays, remote radio heads, and/or the like.

In the above description, the UE, the base station, and the core network node are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above exemplary embodiments, a number of software modules were described. As those skilled in the art will appreciate, the software modules may be provided in compiled or un-compiled form and may be supplied to the UE, the base station, and the core network node as a signal over a computer network, or on a recording medium. Further, the functionality performed by part or all of this software may be performed using one or more dedicated hardware circuits. However, the use of software modules is preferred as it facilitates the updating of the UE, the base station, and the core network node in order to update their functionalities.

The above exemplary embodiments are also applicable to ‘non-mobile’ or generally stationary user equipment.

The above described method may further comprise obtaining, from a core network node, prior to obtaining the information from the at least one SN, information indicating that a total of integrity protected traffic for at least one PDU session associated with the UE has reached a predetermined level.

The updating at least one PDU session associated with the UE at that SN may comprise at least one of: removing at least one DRB associated with the UE; modifying at least one SN terminated bearer associated with the UE to a Master Node (MN) terminated bearer; and dropping said SN from a set of nodes handling user-plane transmissions for the UE.

The method may further comprise allocating at least a portion of a PDU session integrity protected maximum data rate to at least one SN and allocating a remaining portion of the PDU session integrity protected maximum data rate to a master node (MN) of the base station apparatus.

The method may further comprise: obtaining information identifying a total data rate for all PDU sessions associated with the UE at the MN; and when the obtained information indicates that the total data rate for all PDU sessions associated with the UE at the MN exceeds an associated data rate portion, modifying or removing at least one DRB at the MN.

The predetermined level may be a predetermined threshold or a predetermined percentage (e.g. 50%, 60%, 70%, 80%, 90%, or 100%) of an associated maximum integrity protected data rate.

The method may further comprise: obtaining, at a master node (MN) from a core network node, information identifying a maximum data rate allowed for integrity protected data for all PDU sessions associated with the UE; and sending (e.g. at SN addition), to the at least one SN, the obtained information identifying a maximum data rate allowed for integrity protected data for all PDU sessions associated with the UE.

When a PDU session associated with the UE is split at the UPF, the method may further comprise: obtaining, at a master node (MN), from a core network node, at least one information element identifying at least one of: a maximum integrity protected data rate allowed for the UE on a PDU session level; a maximum integrity protected data rate allowed for the UE on a DRB level; and a maximum integrity protected data rate allowed for the UE on a Quality of Service (QoS) flow level; and enforcing the maximum data rate allowed for integrity protected data for all PDU sessions associated with the UE based on the at least one information element.

The method may further comprise forwarding the at least one information element to the SN and monitoring, at the SN, the data rate for integrity protected data for all PDU sessions associated with the UE based on the at least one information element.

The base station apparatus may comprise a distributed base station comprising a central unit (CU) and one or more distributed units (DUs) for handling user-plane transmissions for the UE.

The information from the at least one SN identifying a total integrity protected data rate for all Protocol Data Unit (PDU) sessions associated with the UE at that SN may comprise a data usage report.

The obtaining information from the at least one SN may comprise obtaining said information at least one of: periodically; upon a request from the MN, and when triggered by an event.

When the base station apparatus is coupled to a plurality of units configured to operate as at least a part of an SN, the method may comprise allocating, to each unit, respective portions of said total integrity protected data rate for all PDU sessions associated with the UE. In this case, the method may comprise updating said allocation of said portions in dependence on respective information, obtained from at least one of said units, identifying a total integrity protected data rate for all Protocol Data Unit (PDU) sessions associated with the UE at that unit.

Various other modifications will be apparent to those skilled in the art and will not be described in further detail here.

Some of or all the above-described example embodiments can be described as in the following Supplementary Notes, but are not limited to the following.

(Supplementary Note 1)

A method performed by a base station apparatus, the method comprising: obtaining, from at least one secondary node (SN) handling user-plane transmissions for a user equipment (UE), information identifying a total integrity protected data rate for all Protocol Data Unit (PDU) sessions associated with the UE at that SN; and when the information from the at least one SN indicates that the total integrity protected data rate for all PDU sessions associated with the UE at that SN exceeds an associated data rate portion, updating at least one of: said data rate portion; and at least one PDU session associated with the UE at that SN.

(Supplementary Note 2)

The method according to Supplementary Note 1, further comprising obtaining, from a core network node, prior to obtaining the information from the at least one SN, information indicating that a total of integrity protected traffic for at least one PDU session associated with the UE has reached a predetermined level.

(Supplementary Note 3)

The method according to Supplementary Note 1 or 2, wherein said updating at least one PDU session associated with the UE at that SN comprises at least one of: removing at least one DRB associated with the UE; modifying at least one SN terminated bearer associated with the UE to a Master Node (MN) terminated bearer; and dropping said SN from a set of nodes handling user-plane transmissions for the UE.

(Supplementary Note 4)

The method according to any of Supplementary Notes 1 to 3, further comprising allocating at least a portion of a PDU session integrity protected maximum data rate to at least one SN and allocating a remaining portion of the PDU session integrity protected maximum data rate to a master node (MN) of the base station apparatus.

(Supplementary Note 5)

The method according to any of Supplementary Notes 1 to 4, further comprising: obtaining information identifying a total data rate for all PDU sessions associated with the UE at the MN; and when the obtained information indicates that the total data rate for all PDU sessions associated with the UE at the MN exceeds an associated data rate portion, modifying or removing at least one DRB at the MN.

(Supplementary Note 6)

The method according to any of Supplementary Notes 1 to 5, wherein the predetermined level is a predetermined threshold or a predetermined percentage (e.g. 50%, 60%, 70%, 80%, 90%, or 100%) of an associated maximum integrity protected data rate.

(Supplementary Note 7)

The method according to any of Supplementary Notes 1 to 6, further comprising: obtaining, at a master node (MN) from a core network node, information identifying a maximum data rate allowed for integrity protected data for all PDU sessions associated with the UE; and sending (e.g. at SN addition), to the at least one SN, the obtained information identifying a maximum data rate allowed for integrity protected data for all PDU sessions associated with the UE.

(Supplementary Note 8)

The method according to any of Supplementary Notes 1 to 7, wherein, when a PDU session associated with the UE is split at the UPF, the method further comprises: obtaining, at a master node (MN), from a core network node, at least one information element identifying at least one of: a maximum integrity protected data rate allowed for the UE on a PDU session level; a maximum integrity protected data rate allowed for the UE on a DRB level; and a maximum integrity protected data rate allowed for the UE on a Quality of Service (QoS) flow level; and enforcing the maximum data rate allowed for integrity protected data for all PDU sessions associated with the UE based on the at least one information element.

(Supplementary Note 9)

The method according to Supplementary Note 8, further comprising forwarding the at least one information element to the SN and monitoring, at the SN, the data rate for integrity protected data for all PDU sessions associated with the UE based on the at least one information element.

(Supplementary Note 10)

The method according to any of Supplementary Notes 1 to 9, wherein the base station apparatus comprises a distributed base station comprising a central unit (CU) and one or more distributed units (DUs) for handling user-plane transmissions for the UE.

(Supplementary Note 11)

The method according to any of Supplementary Notes 1 to 10, wherein the information from the at least one SN identifying a total integrity protected data rate for all Protocol Data Unit (PDU) sessions associated with the UE at that SN comprises a data usage report.

(Supplementary Note 12)

The method according to any of Supplementary Notes 1 to 11, wherein said obtaining information from the at least one SN comprises obtaining said information at least one of: periodically; upon a request from the MN, and when triggered by an event.

(Supplementary Note 13)

The method according to any of Supplementary Notes 1 to 12, wherein when the base station apparatus is coupled to a plurality of units configured to operate as at least a part of an SN, the method comprises allocating, to each unit, respective portions of said total integrity protected data rate for all PDU sessions associated with the UE.

(Supplementary Note 14)

The method according to Supplementary Note 13, comprising updating said allocation of said portions in dependence on respective information, obtained from at least one of said units, identifying a total integrity protected data rate for all Protocol Data Unit (PDU) sessions associated with the UE at that unit.

(Supplementary Note 15) A method performed by a base station apparatus configured as a secondary node (SN) handling user-plane transmissions for a user equipment (UE), the method comprising: providing, to a master node (MN) or a control-plane unit, information identifying a total integrity protected data rate for all Protocol Data Unit (PDU) sessions associated with the UE at that SN; and when the total integrity protected data rate for all PDU sessions associated with the UE at that SN exceeds an associated data rate portion, updating at least one of: said data rate portion; and at least one PDU session associated with the UE at that SN.

(Supplementary Note 16) A method performed by a core network node handling user-plane transmissions for a user equipment (UE), the method comprising: providing, to a master node (MN), information indicating that a total of integrity protected traffic for at least one Protocol Data Unit (PDU) session associated with the UE has reached a predetermined level.

(Supplementary Note 17)

A computer program product comprising instructions to perform a method according to any preceding Supplementary Note.

(Supplementary Note 18)

Base station apparatus comprising: a controller and a transceiver, the controller being configured to: obtain, from at least one secondary node (SN) handling user-plane transmissions for a user equipment (UE), information identifying a total integrity protected data rate for all Protocol Data Unit (PDU) sessions associated with the UE at that SN; and when the information from the at least one SN indicates that the total integrity protected data rate for all PDU sessions associated with the UE at that SN exceeds an associated data rate portion, to update at least one of: said data rate portion; and at least one PDU session associated with the UE at that SN.

(Supplementary Note 19)

A base station apparatus configured as a secondary node (SN) handling user-plane transmissions for a user equipment (UE), the base station apparatus comprising: a controller and a transceiver, the controller being configured to: provide, to a master node (MN) or a control-plane unit, information identifying a total integrity protected data rate for all Protocol Data Unit (PDU) sessions associated with the UE at that SN; and when the total integrity protected data rate for all PDU sessions associated with the UE at that SN exceeds an associated data rate portion, update at least one of: said data rate portion; and at least one PDU session associated with the UE at that SN.

(Supplementary Note 20)

A core network node for handling user-plane transmissions for a user equipment (UE), the core network node comprising: a controller and a transceiver, the controller being configured to: provide, to a master node (MN), information indicating that a total of integrity protected traffic for at least one Protocol Data Unit (PDU) session associated with the UE has reached a predetermined level.

This application is based upon and claims the benefit of priority from United Kingdom Patent Application No. 1902167.4, filed on Feb. 15, 2019, the disclosure of which is incorporated herein in its entirety by reference.

What is claimed is:

1. A method performed by a base station apparatus, the method comprising:
obtaining, from a core network node, information indicating that a total of integrity protected traffic for at least one Protocol Data Unit (PDU) session associated with a user equipment (UE) has reached a predetermined level.

2. The method according to claim 1, further comprising obtaining:
obtaining, from at least one secondary node (SN) handling user-plane transmissions for the UE, information identifying a total integrity protected data rate for all PDU sessions associated with the UE at that SN; and
when the information from the at least one SN indicates that the total integrity protected data rate for all PDU sessions associated with the UE at that SN exceeds an associated data rate portion, updating at least one of: said data rate portion; and at least one PDU session associated with the UE at that SN.

3. The method according to claim 1, wherein said updating at least one PDU session associated with the UE at that SN comprises at least one of: removing at least one DRB associated with the UE; modifying at least one SN terminated bearer associated with the UE to a Master Node (MN) terminated bearer; and dropping said SN from a set of nodes handling user-plane transmissions for the UE.

4. The method according to claim 1, further comprising allocating at least a portion of a PDU session integrity protected maximum data rate to at least one SN and allocating a remaining portion of the PDU session integrity protected maximum data rate to a master node (MN) of the base station apparatus.

5. The method according to claim 1, further comprising:
obtaining information identifying a total data rate for all PDU sessions associated with the UE at the MN; and
when the obtained information indicates that the total data rate for all PDU sessions associated with the UE at the MN exceeds an associated data rate portion, modifying or removing at least one DRB at the MN.

6. The method according to claim 1, wherein the predetermined level is a predetermined threshold or a predetermined percentage of an associated maximum integrity protected data rate.

7. The method according to claim 1, further comprising:
obtaining, at a master node (MN) from a core network node, information identifying a maximum data rate allowed for integrity protected data for all PDU sessions associated with the UE; and
sending, to the at least one SN, the obtained information identifying a maximum data rate allowed for integrity protected data for all PDU sessions associated with the UE.

8. The method according to claim 1, wherein, when a PDU session associated with the UE is split at the UPF, the method further comprises:
obtaining, at a master node (MN), from a core network node, at least one information element identifying at least one of: a maximum integrity protected data rate allowed for the UE on a PDU session level; a maximum integrity protected data rate allowed for the UE on a DRB level; and a maximum integrity protected data rate allowed for the UE on a Quality of Service (QoS) flow level; and
enforcing the maximum data rate allowed for integrity protected data for all PDU sessions associated with the UE based on the at least one information element.

9. The method according to claim 8, further comprising forwarding the at least one information element to the SN and monitoring, at the SN, the data rate for integrity protected data for all PDU sessions associated with the UE based on the at least one information element.

10. The method according to claim 1, wherein the base station apparatus comprises a distributed base station comprising a central unit (CU) and one or more distributed units (DUs) for handling user-plane transmissions for the UE.

11. The method according to claim 2, wherein the information from the at least one SN identifying a total integrity protected data rate for all Protocol Data Unit (PDU) sessions associated with the UE at that SN comprises a data usage report.

12. The method according to claim 2, wherein said obtaining information from the at least one SN comprises obtaining said information at least one of: periodically; upon a request from the MN, and when triggered by an event.

13. The method according to claim 1, wherein when the base station apparatus is coupled to a plurality of units configured to operate as at least a part of an SN, the method comprises allocating, to each unit, respective portions of said total integrity protected data rate for all PDU sessions associated with the UE.

14. The method according to claim 13, comprising updating said allocation of said portions in dependence on respective information, obtained from at least one of said units, identifying a total integrity protected data rate for all Protocol Data Unit (PDU) sessions associated with the UE at that unit.

15. (canceled)

16. A method performed by a core network node handling user-plane transmissions for a user equipment (UE), the method comprising:
providing, to a master node (MN), information indicating that a total of integrity protected traffic for at least one Protocol Data Unit (PDU) session associated with the UE has reached a predetermined level.

17. (canceled)

18. Base station apparatus configured as a master node (MN) comprising:
a controller and a transceiver, the controller being configured to:
obtain, from a core network node, information indicating that a total of integrity protected traffic for at least one Protocol Data Unit (PDU) session associated with a user equipment (UE) has reached a predetermined level.

19. (canceled)

20. A core network node for handling user-plane transmissions for a user equipment (UE), the core network node comprising:
a controller and a transceiver, the controller being configured to:
provide, to a master node (MN), information indicating that a total of integrity protected traffic for at least one Protocol Data Unit (PDU) session associated with the UE has reached a predetermined level.
